(19) United States
(12) Patent Application Publication
(10) Pub. No.: US 2009/0199751 A1
(43) Pub. Date: Aug. 13, 2009

(54) TREE SPADE ASSEMBLY FOR EXCAVATING AND IMPLANTING

(76) Inventor: John Liebl, Atwater, MN (US)

Correspondence Address: WESTMAN CHAMPLIN & KELLY, P.A., SUITE 1400, 900 SECOND AVENUE SOUTH, MINNEAPOLIS, MN, 55402, US

(21) Appl. No.: 12/028,112

(22) Filed: Feb. 8, 2008

(51) Int. Cl. A01C 11/00

(52) U.S. Cl. 111/101; 172/772.5

(57) ABSTRACT

A tree spade assembly for excavating and implanting a tree ball. The tree spade assembly includes a circular mainframe defining a vertically oriented central axis, a post coupled to the mainframe and defining a post axis at an acute angle with respect to the central axis, a slider movably coupled to the post for sliding along the post axis, and a blade coupled to the slider. The blade includes a reinforcing feature extending the length of the blade substantially parallel to the post axis. The reinforcing feature defines a recessed channel in an outer surface of the blade and a rib on an inner surface of the blade that positions a tip of the blade inward from the outer contour of the blade.

### FIELD OF THE INVENTION

The present invention relates to a tree spade assembly for excavating and implanting tree balls.

### SUMMARY

In one embodiment, the invention provides a blade for a tree spade assembly for excavating and implanting a tree ball. The blade has a concave surface, a convex surface, a lower blade tip and a reinforcing feature. The reinforcing feature defines a recess in the convex surface of the blade that extends longitudinally along the blade upward from the lower blade tip.

In another embodiment, the invention provides a tree spade assembly for excavating and implanting a tree ball including a mainframe defining a central axis, a post coupled to the mainframe and defining a post axis at an acute angle with respect to the central axis, a slider movably coupled to the post and slidable along the post axis and a blade coupled to the slider. The blade has a first surface facing toward the central axis of the mainframe and a second surface facing away from the central axis of the mainframe. A rib on the blade extends substantially parallel to the post axis and protrudes inward from the first surface toward the central axis.

In another embodiment, the invention provides a tree spade assembly for excavating and implanting a tree ball including a mainframe defining a central axis, a post coupled to the mainframe and defining a post axis at an acute angle with respect to the central axis, a slider movably coupled to the post and slidable along the post axis and a blade coupled to the slider. The blade has a first surface facing toward the central axis of the mainframe and a second surface facing away from the central axis of the mainframe. A recessed channel in the second surface of the blade extends substantially parallel to the post axis.

Other aspects of the invention will become apparent by consideration of the detailed description and accompanying drawings.

### BRIEF DESCRIPTION OF THE DRAWINGS

FIG. 1 is a side view of a skid steer loader for use with embodiments of the invention.

FIG. 2 is a perspective view of the skid steer loader shown in FIG. 1.

FIG. 3 is a perspective view of a tree spade assembly according to one embodiment of the invention.

FIG. 4 is a perspective view of a tree spade blade for the tree spade assembly shown in FIG. 3.

FIG. 5 is a plan view of the tree spade blade shown in FIG. 4.

FIG. 6 illustrates the operation of the tree spade assembly shown in FIG. 3.

FIG. 7 illustrates a central rib of the tree spade blade shown in FIG. 4.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

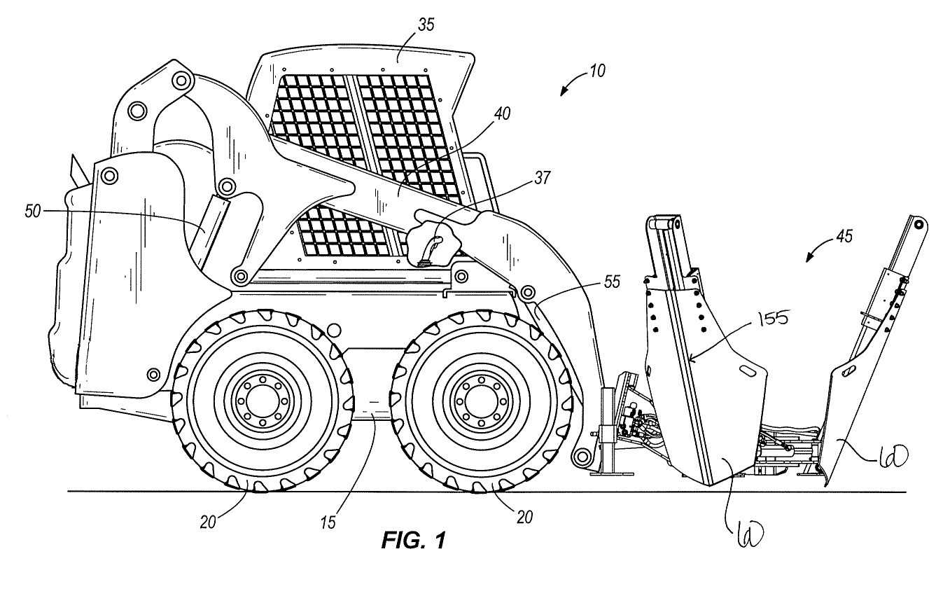

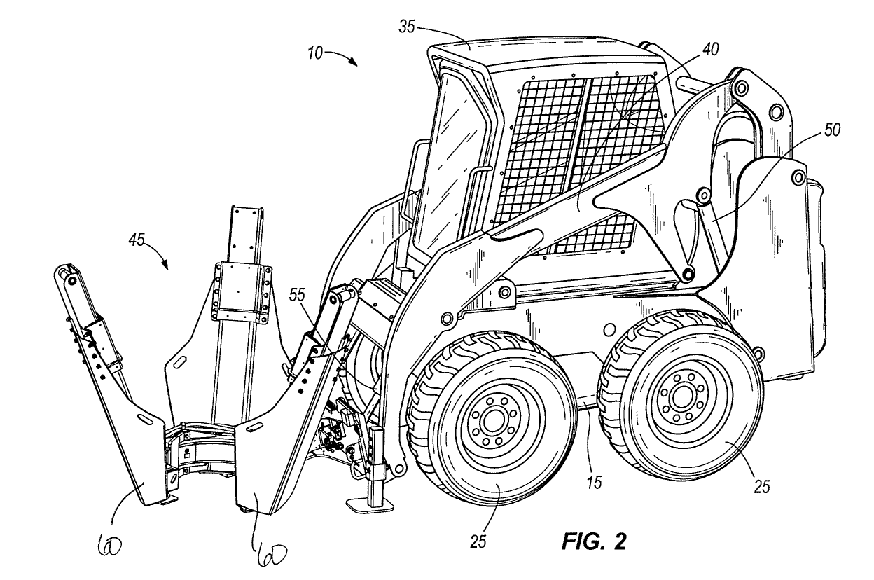

FIGS. 1 and 2 depict a skid steer loader 10 having a frame 15 supported by two right side wheels 20 and two left side wheels 25. The loader 10 further includes an internal combustion engine (not visible), an operator compartment 35 that contains an operator control 37, right and left lift arms 40, and a tree spade assembly 45 mounted to the distal ends of the lift arms 40. Although the invention is illustrated embodied in a skid steer loader 10, the invention may be embodied in other vehicles and machines.

The lift arms 40 raise (i.e., rotate counterclockwise in FIG. 1) and lower (i.e., rotate clockwise in FIG. 1) with respect to the frame 15 under the influence of lift cylinders 50 mounted between the frame 15 and the lift arms 40. The tree spade assembly 45 pivots with respect to the arms 40 under the influence of tilt cylinders 55 mounted between the lift arms 40 and the tree spade assembly 45.

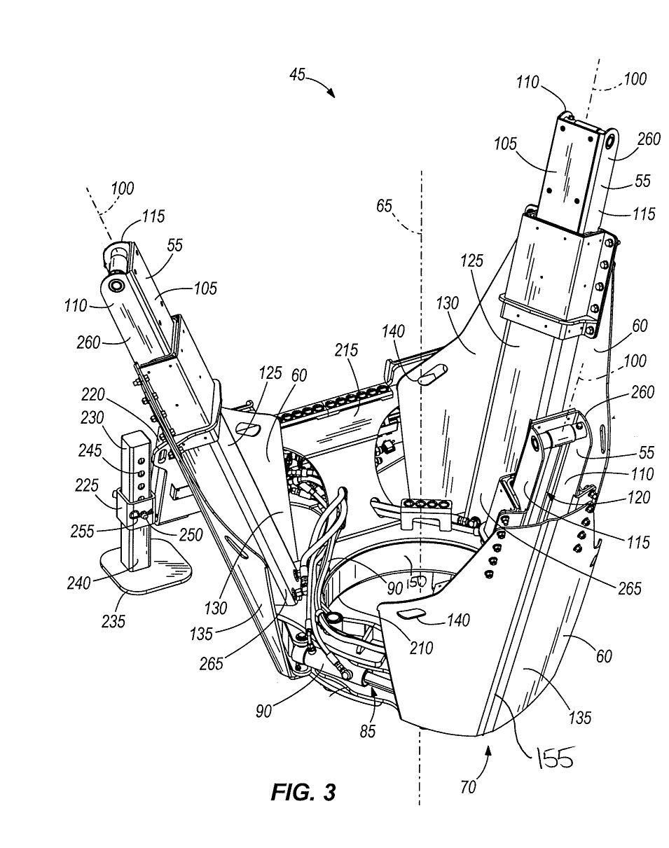

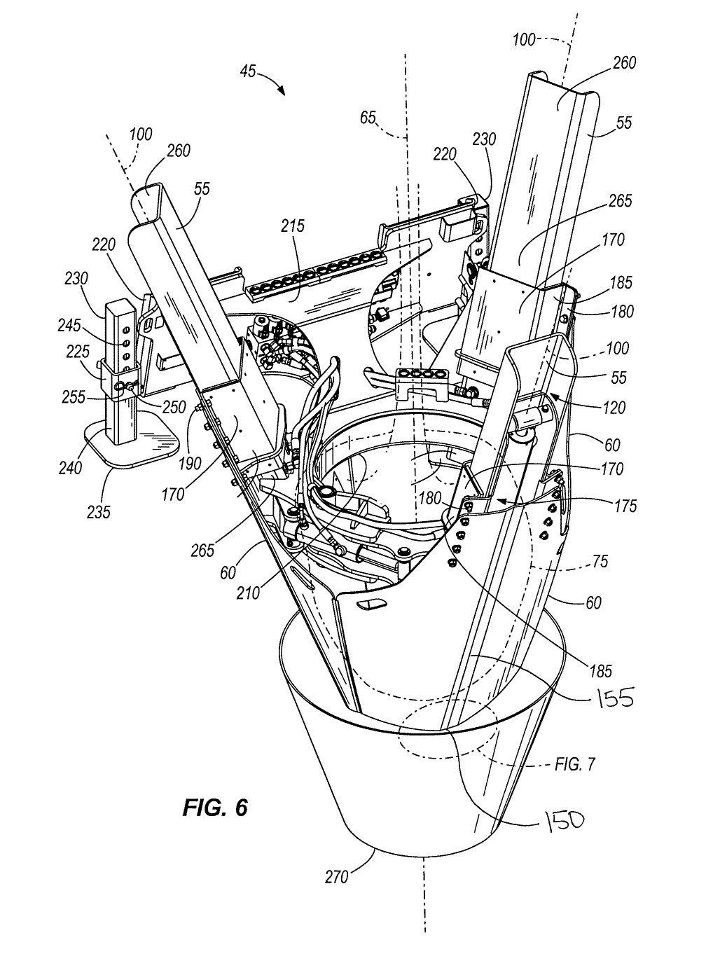

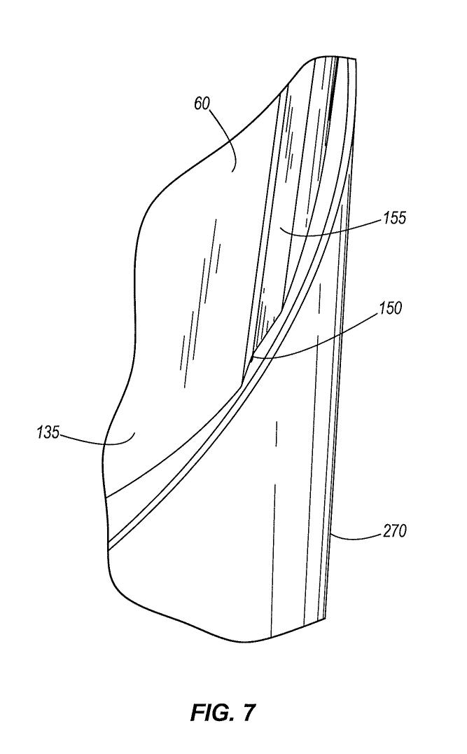

FIG. 3 illustrates the tree spade assembly 45, which includes a mainframe 50, a plurality of towers or posts 55 coupled to the mainframe 50, and a spade or blade 60 movably coupled to each of the posts 55. The mainframe 50 is a circular structure defining a substantially vertically oriented central axis 65. A gate portion 70 of the mainframe 50 is pivotably coupled to the mainframe 50 so as to pivot between open and closed positions. The gate portion 70 pivots to open and close a leading edge 72 of the gate portion 70 relative to the mainframe 50. Opening the leading edge 72 away from the mainframe 50 allows the mainframe 50 to surround a tree ball 75 (shown as a phantom object in FIG. 6) that is to be either excavated from or implanted into a substrate, such as soil. The gate portion 70 can include at least one post 55 and blade 60 combination.

The mainframe 50 may also include one or more cavities or channels 85 for storing hydraulic components 90 of the tree spade assembly 45. The channel 85 is on an outer perimeter of the mainframe 50 so as to avoid interfering with a tree ball 75 carried within the mainframe 50. Hydraulic components 90 (i.e., tubes, fittings, cylinders, valves, etc.) provide power and operational control to the structures of the tree spade assembly 45 (e.g., the blades of the tree spade assembly) from hydraulic controls located within the operator compartment 35.

Each post 55, as illustrated in FIG. 3, has a U-shaped cross-section and extends in a longitudinal direction to define respective post axes 100. The post axes 100 are inclined from the central axis 65 at similar acute angles such that a conical-like space is created by the mainframe 50 and posts 55. In other constructions, the tree spade assembly 45 may include more or less than the three posts 55 and three blades 60 illustrated in FIG. 3. In the preferred construction, the three posts 55 are welded to the mainframe 50. However, in other constructions, the posts 55 may be secured to the mainframe 50 by bolting, riveting, gluing, crimping, etc., or may be integrally formed with the mainframe 50.

A first side 105 of each post 55 faces the central axis 65 of the mainframe 50 (i.e., towards the center of the tree spade assembly 45), and second and third sides 110, 115 of each post 55 oppose one another. The three sides 105, 110, 115 of each post 55 form respective channels 120 with an opening facing away from the central axis 65 (i.e., away from the center of the tree spade assembly 45). The hydraulic components 90 discussed above may be housed within the channels 120 of the posts 55. Each post 55 may also have an outer sleeve 125 proximate the mainframe 50. The sleeves 125 may surround respective posts 55 as to cover and protect the hydraulic components 90 contained within the channel 120 of each respective post 55.

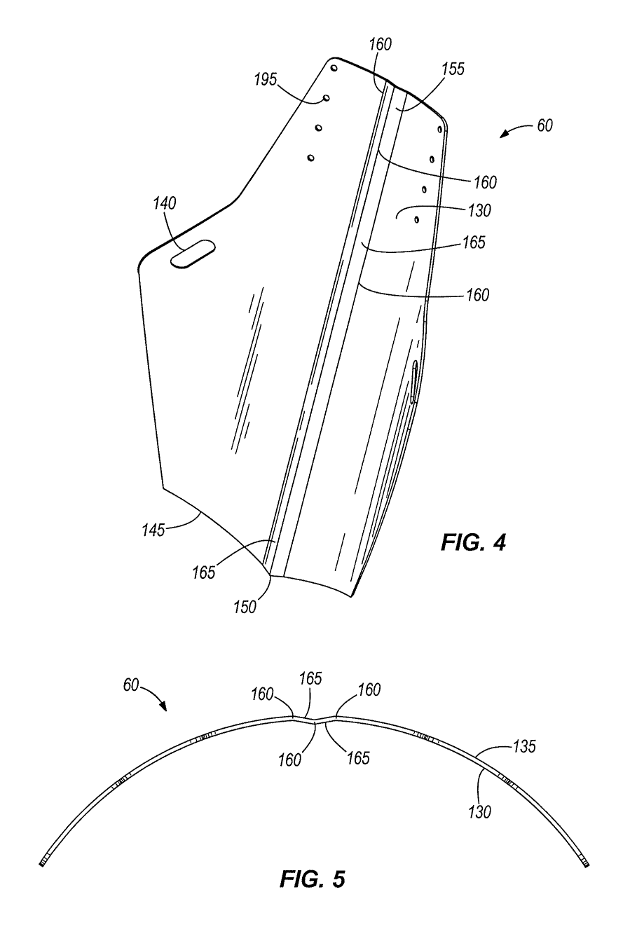

With reference to FIGS. 3-5, the blades 60 are generally arc-shaped or rounded v-shaped and include a concave surface (i.e., a first surface 130) facing toward the central axis 65, and a convex surface (i.e., a second surface 135) facing away from the central axis 65. Each blade 60 also includes a pair of blade handles 140 (FIGS. 3 and 4). However, in other constructions, the blades 60 may have more or fewer (e.g., zero) handles than that depicted. Each blade 60 is similar in construction; therefore, as the structure and configuration of one of the three blades 60 is described below, the same reference is applicable to each blade 60.

As shown in FIG. 4, the blade 60 (i.e., each of the three blades 60) includes a lower cutting edge 145 extending between the first and second surfaces 130, 135 of the blade 60. The cutting edge 145 defines an apex hereinafter referred to as the blade tip 150 of the blade 60. The blade 60 also includes a longitudinal reinforcing feature 155. The reinforcing feature 155 increases the stiffness of the blade 60 and inhibits deformation of the blade 60.

The reinforcing feature 155 extends upwards from the blade tip 150 along the longitudinal length of the blade 60 at approximately the center of the blade 60. In other constructions, the reinforcing feature 155 may only extend for a portion of the longitudinal length of the blade 60 upwards from the blade tip 150. In the illustrated embodiment, the reinforcing feature 155 is in the form of a V-shaped rib protruding inwardly towards the central axis 65 of the mainframe 50. The reinforcing feature 155 defines a recessed channel 157 at the second, outer surface 135 of the blade 60. The blade tip 150 is formed on the reinforcing feature 155 such that the blade tip 150 is positioned inwardly of the outer contour of the blade 60 at the outer surface 135. In other embodiments, the blade 60 lacks the channel 157 so that the blade tip 150 is merely positioned on an inward portion of the reinforcing feature 155 relative to the outer contour of the blade 60.

The blade 60 is a single metal sheet manufactured by a rolling process. The blade 60 may also be manufactured by other known machining processes, such as stamping, extruding, etc. The reinforcing feature 155 of the blade 60 is formed by creating multiple bends proximate the center of the blade 60, such that the blade 60 and reinforcing feature 155 combination is a single sheet of material. Each bend creates a longitudinally extending edge 160 of the reinforcing feature 155 such that multiple bends create edge surfaces 165 therebetween. In one construction, as shown in FIG. 5, the reinforcing feature 155 is formed of three edges 160 forming a v-shaped rib. In another construction, the reinforcing feature 155 may be formed of four edges defining a rectangular-shaped rib. In another construction, the reinforcing feature 155 may have more or fewer than four bends such that the bends define a semi-circular shaped reinforcing feature 155. In other constructions, the reinforcing feature 155 may take the form of any shape such that the reinforcing feature 155 positions the blade tip 150 inwardly and away from the second surface 135.

With respect to FIGS. 3 and 6, each blade 60 is movably coupled to respective posts 55 via blade sliders 170. The sliders 170 are slidable coupled to the posts 55 so as to be movable along the post axis 100 to raise and lower the blades 60 relative to the mainframe 50. Each blade slider 170 defines a rectangular-shaped channel 175 that partially surrounds each respective post 55. Each slider 175 includes a pair of flanges 180 having fasteners 190 for coupling within apertures 195 of the blade 60.

The tree spade assembly 45 further includes a mounting frame 215 coupled to the mainframe 50. The pair of uprights 230 and respective bases 235 of the mounting frame 215 assist in the leveling, supporting, and stabilizing the tree spade assembly 45 prior to and during operation. In the preferred construction, the mounting frame 215 is welded to the mainframe 50. However, in other constructions, the mounting frame 215 may be coupled to the mainframe 50 by bolting, riveting, gluing, crimping, etc., or may be integrally formed with the mainframe 50. The mounting frame 215 includes a pair of ends 220. Each end 220 includes a sleeve 225 coupled to the mounting frame 215. An adjustable upright 230 is received in the sleeve 225 such that the sleeve 225 slides vertically over the upright 230. A base 235 is coupled to a bottom end 240 of the upright 230. Each upright 230 includes a plurality of height-adjusting apertures 245 for which a pin 250 of the sleeve 225 engages and disengages to adjust the height of the mounting frame 215 relative to the upright 230. The pins 250 of the sleeves 225 are locked into one of the apertures 245 of one of the uprights 230 by a cotter pin 255 or other removable fastener.

FIG. 3 illustrates the tree spade assembly 45 in a first configuration. In the first configuration, the blades 60 are proximate a top end 260 of each post 55 and do not substantially extend below the mainframe 50. The blades 60 are spaced apart from one another. FIG. 6 illustrates the tree spade assembly 45 in a second configuration, in which the blades 60 are lowered on the posts 55 relative to the mainframe 50. In the second configuration, the blades 60 extend substantially below the mainframe 50 and are closer to one another.

To operate, the tree spade assembly 45 is either placed adjacent a tree ball 75 while in the first configuration. The tree ball 75 may be located within a substrate or in a carrier 270. The carrier 270 is a wire basket used for transporting the tree ball 75. The gate portion 70 is actuated to swing open and the mainframe 50 is positioned about the tree ball 75. The gate portion 70 is closed so that the mainframe 50 surrounds the tree ball 75. The sliders 170 and blades 60 are then moved from the top end 260 of the posts 55 (i.e., from the first configuration), along the longitudinal axes 100 of the posts 55, and toward the bottom end 265 of the posts 55 (i.e., the second configuration). Movement of the sliders 170 can be powered via hydraulics and can be controlled within the operator compartment 37. The blades 60 of the assembly 45 are forced either into the substrate (e.g., soil) or carrier 270 (e.g., wire basket) by the sliders 170. As the blades 60 are lowered, the tree ball 75 is captured within the conical space defined by the blades 60 in the second configuration. The lift arms 40 are then raised for lifting the tree spade assembly 45 and the tree ball 75 free of the substrate or carrier 270 for transportation. These steps are reversed to deposit a tree ball into a carrier 270 or into a substrate (i.e., the ground or a planting bed).

With reference to FIGS. 6 and 7, the blade tip 150 is recessed from the outer surface 135 of the blade 60. The recessed blade tip 150 resists interfering with the carrier 270 during while raising or lowering of the tree spade assembly 45 into the carrier 270. Interference may include instances when the blade tip 150 snags in the wire basket 270, or friction between the blade 60 and carrier 270. The reinforcing feature 155 strengthens the blade 60 and inhibits deformation of the blade 60.

In other constructions, the tree spade assembly 45 may be used to excavate and transplant other objects, such as boulders, posts, shrubs, etc.

Thus, the invention provides, among other things, a tree spade assembly for excavating and implanting tree balls. Various features and advantages of the invention are set forth in the following claims.

What is claimed is:

1. A blade for a tree spade assembly for excavating and implanting a tree ball, the blade comprising:
a blade having a concave surface;
a convex surface opposite the concave surface;
a lower blade tip; and
a reinforcing feature on the blade, the reinforcing feature defining a recess in the convex of the blade that extends longitudinally along the blade upward from the lower blade tip.

2. The blade of claim 1, wherein the reinforcing feature is a V-shaped rib protruding inwardly from the blade concave surface.

3. The blade of claim 1, wherein the recess is defined by multiple surfaces of the blade forming a channel extending the length of the blade.

4. The blade of claim 1, wherein the blade is v-shaped and the reinforcing feature forms a longitudinal apex of the blade.

5. The blade of claim 1, wherein the reinforcing feature is integrally formed with the blade.

6. The blade of claim 1, wherein the blade tip is recessed from the convex surface of the blade.

7. The blade of claim 1, wherein the blade includes a handle.

8. A tree spade assembly for excavating and implanting a tree ball, the tree spade assembly comprising:
a mainframe defining a central axis;
a post coupled to the mainframe and defining a post axis at an acute angle with respect to the central axis;
a slider movably coupled to the post and slidable along the post axis;
a blade coupled to the slider, the blade having a first surface facing toward the central axis of the mainframe and a second surface facing away from the central axis of the mainframe; and
a rib on the blade, the rib extending substantially parallel to the post axis and protruding inward from the first surface toward the central axis.

9. The tree spade assembly of claim 8, wherein the blade is folded to form the rib.

10. The tree spade assembly of claim 8, further comprising a recess in the second surface of the blade opposite the rib.

11. The tree spade assembly of claim 8, wherein the blade is v-shaped and the rib forms a longitudinal apex of the blade.

12. The tree spade assembly of claim 8, wherein the rib is integrally formed with the blade.

13. The tree spade assembly of claim 8, wherein the blade includes a blade tip at an end of the rib.

14. The tree spade assembly of claim 13, wherein the blade tip is recessed from the second surface of the blade toward the central axis of the mainframe.

15. The tree spade assembly of claim 8, wherein the mainframe includes an openable gate portion.

16. A tree spade assembly for excavating and implanting a tree ball, the tree spade assembly comprising:
a mainframe defining a central axis;
a post coupled to the mainframe and defining a post axis at an acute angle with respect to the central axis;
a slider movably coupled to the post and slidable along the post axis;
a blade coupled to the slider, the blade having a first surface facing toward the central axis of the mainframe and a second surface facing away from the central axis of the mainframe; and
a recessed channel in the second surface of the blade, the recessed channel extending substantially parallel to the post axis.

17. The tree spade assembly of claim 16, wherein the blade is folded to form the recessed channel.

18. The tree spade assembly of claim 16, further comprising a rib in the first surface of the blade opposite the recessed channel.

19. The tree spade assembly of claim 16, wherein the blade includes a blade tip at an end of the blade adjacent to the recessed channel, wherein the blade tip is recessed from the second surface of the blade toward the central axis of the mainframe.
